(19) United States
(12) Patent Application Publication
(10) Pub. No.: US 2018/0131696 A1
(43) Pub. Date: May 10, 2018

(54) SYSTEMS AND METHODS FOR PROVIDING DYNAMIC AUTHORIZATION

(71) Applicant: ProSoft Technology, Inc., Bakersfield, CA (US)

(72) Inventor: Daniel Wade, Pleasanton, CA (US)

(21) Appl. No.: 15/808,243

(22) Filed: Nov. 9, 2017

Related U.S. Application Data
(60) Provisional application No. 62/419,660, filed on Nov. 9, 2016.

(51) Int. Cl. H04L 29/06

(52) U.S. Cl. CPC H04L 63/10; H04L 63/0272; H04L 63/0876; H04L 63/029

(57) ABSTRACT

Systems, methods, and computer-readable media are disclosed for providing dynamic authorization by receiving requests for access to a resource or configuration element, sending a notification to a member of an authorization group based on the request, receiving a response to the notification, determining whether to grant authorization to the resource or configuration element based on the response, responding to the request for access with a notification that access is denied based on determining to deny authorization, and setting up a virtual private network tunnel or using software-defined networking to allow access to the resource or configuration element based on determining to allow authorization.

### RELATED APPLICATION

The present application claims the benefit of, and priority to, U.S. Provisional Patent Application No. 62/419,660, entitled “SYSTEMS AND METHODS FOR PROVIDING DYNAMIC AUTHORIZATION,” filed Nov. 9, 2016, the entirety of which is hereby incorporated by reference.

### BACKGROUND

Various systems can utilize multifactor authentication to validate users requesting access to the system or resources managed by the system. For example, a first factor can be a unique password, a second factor can be a uniquely rotating alphanumeric code tied to that user, and a third factor can be a biometric like a finger print or retina scan. Each one the factors contributes to authenticating the identity of the user.

Systems that use multifactor authentication may require predetermined and static access control lists or whitelists of authorized user credentials, user devices, machine addresses, internet protocol (IP) addresses, port numbers, etc. Adding and/or removing users from a list can be a cumbersome, inefficient, and a time-consuming process.

### SUMMARY

Systems, methods, and computer-readable media are disclosed for providing dynamic authorization by receiving requests for access to a resource or configuration element, sending a notification to a member of an authorization group based on the request, receiving a response to the notification, determining whether to grant authorization to the resource or configuration element based on the response, responding to the request for access with a notification that access is denied based on determining to deny authorization, and setting up a virtual private network tunnel or using software-defined networking to allow access to the resource or configuration element based on determining to allow authorization.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings.

FIG. 1 illustrates an example system diagram, according to an embodiment.

FIG. 2 illustrates an example of a method for managing authorizations, according to an embodiment.

FIG. 3 illustrates an example system diagram, according to an embodiment.

FIG. 4 illustrates an example of a method for managing authentications, according to an embodiment.

FIG. 5 illustrates an example of a method for requesting access to servers in a system, according to an embodiment.

FIG. 6 illustrates an example hardware system for managing authorizations, according to an embodiment.

### DETAILED DESCRIPTION

Embodiments of the present disclosure may provide an authentication system with a dynamic authorization process. In some embodiments, the authentication system can be a multifactor authentication system.

Group Factor Authorization (GFA) is a system in which a user is granted or denied permission for access, configuration, and/or remote access tunneling after a predetermined number of members of an authorization group have approved/denied the access for the amount of time requested and for the time of day that access has been requested. A GFA can, in some embodiments, prevent additional users from configuration and/or remote access tunneling while the requestor is accessing the configuration and/or tunnel. In some instance, a GFA can reduce the risk of serious injury or death by preventing access to resources until the GFA members have granted access and by preventing others from accessing critical resources at the same time. Members in a GFA group could include specific entities such as the production supervisor, plant manager, shift supervisor, personal manager, IT manager and/or coworkers who must agree or authorize access at the time requested and for the duration requested. GFA members might also include roles where a role is not specific to a particular user, and any user can be given that role.

In some embodiments, a user may desire to access multiple GFA systems. Accordingly, the user may be granted access to each system by the respective authorization group for that system. Once granted access, in some instances, the user may have to create and/or be provided with authentication factors, such as a password, a rotating alphanumeric code, and or a biometric for each system. Creating and/or providing authentication factors for each system can result in use of the processing resources of a device of the user and/or devices of the system, as well as network resources for the various communications used to communicate the authentication factors between devices. In systems where there are many entities being granted access at any given time, this can result in network and/or processing latency and/or may require the system to have extensive processing and/or network resources.

In some implementations, the above described technical problems can be addressed by an authorization management service that can be used to manage authentication factors for a user that can be used with multiple GFA systems. For example, an account for a user can be created, and a password and/or biometric information can be submitted from a device associated with the user. Additionally, the authorization management service can generate a rotating alphanumeric code for the user, when needed. When the user is granted access to resources or configuration elements of a GFA system, the authorization management service can authenticate the user using the authentication factors associated with the account of the user. In various embodiments, the same authentication factors can be used for potentially several different GFA systems to which the user is granted access. Thus, the network and/or processing latency described above is alleviated because the user is not required to submit and/or receive authentication factors for each system that is accessed.

In some implementations, an automated approach for GFA can be provided where the authorization request is sent to all members of the authorization group electronically through such electronic media as emails, text messages, social media (e.g., TWITTER® or FACEBOOK®), IOS® or ANDROID® mobile operating system push notifications, and/or a web-based service (e.g., IFTTT®). In other implementations, physical media can be used for authorization requests, such as physical tickets or printouts that can be read by members of the authorization group (e.g., using scanners, cameras, or other input devices). Depending on the GFA configuration, one, all, or some configurable number of GFA members may be specified to authorize the activity. In some embodiments, a group member can reply using the same method the request was sent in (e.g., using electronic or physical media). In other embodiments, a group member can reply using a different method. For example, a request can be sent via an email, and the group member can reply using a text message.

The system can notify the requesting user of success or failure, and can grant access for the duration of a requested amount of time to one or more resources or configuration elements at the appointed time. GFA can also prevent or lock out other users from accessing the configuration elements or resources during that time according to the configured policy and/or request (e.g., using a semaphore data type). GFA can additionally allow the requesting user to view identifiers of other users accessing or locking out a system, a resource, a configuration element, etc. Additionally, GFA can disable access for the requesting user when the granted duration has ended. The system can also log requests, responses, and authorization events.

Thus, the system allows authorization group members, which can be selected in advance, to dynamically authorize users to access resources or configuration elements of a system. In various embodiments, a user requesting access or configuration may have access to an authorization management application associated with an authorization management service that includes a user interface (UI) with a “connect” or a “tunnel” button. In such an example, when the user clicks on the connect button, the user's device can begin the process for connecting the device to a remote resource and/or configuration server.

In some embodiments, once the user clicks the connect button, the user's device can send an email, a text message, or a push notification in the background to some or all members of the authorization group. Some or all of the members of the authorization group can respond to that request by replying back to the email, text, push notifications, etc., and the reply can indicate whether the member authorizes the access requested. For example, a member may have an authorization management mobile application on their phone that notifies them when a request is received and allows them to allow or deny the request via the application.

In some instances, when the requesting user clicks the connect button, the UI may request that the user specify the amount of time for the authorization, the time of day of the authorization, a description of the task to be performed, and/or a reason for requesting access.

If the requisite number of members grant access (e.g., all members, a predetermined number of members, a predetermined percentage of members, one member, a super authorizer that can override the votes of other members, a predetermined number of members that can override a super authorizer, etc.), a resource and/or configuration server can provide a virtual private network (VPN) tunnel to the device of the requesting user to allow the user access to resources and/or configurations. In other embodiments, if a device is granted access, then the resource and/or configuration server can provide access using software-defined networking (SDN) to create a path through a network that allows or grants the device access in the network. For example, an SDN can be associated with access control lists (ACLs), which can block or allow traffic on specific physical ports or Internet Protocol (IP) ports. GFA could be used to allow traffic (e.g., all traffic or specific types of traffic, such as Hypertext Transfer Protocol (HTTP), Internet Control Message Protocol (ICMP), or Transmission Control Protocol (TCP)) from the requestor through the network.

By providing a VPN tunnel or using SDN, the server can provide a private and secure network across a public network, such as the internet. Thus, a remote requesting user that is allowed access may be able to access the resource and/or configuration server as if the requesting user was local to the server.

In some embodiments, the VPN tunneling or SDN can be facilitated or executed through a cloud service. In further embodiments, instead of the requesting user that has been granted access having to set up multiple certificates (e.g., Secure Sockets Layer (SSL) certificates), and/or set up other tunneling and networking configurations, the user may only have to click the connect or tunnel button, and a temporary unique password can be generated for the user. The temporary unique password may only be available for a short period of time (e.g., for as long as the user has been granted access to the server). The password will allow the user to have access to the server and to create the VPN tunnel between the user's device and server or use SDN.

In other embodiments, once the requesting user is granted access, the user may have to submit other authentication factors, such as the user's password with the system, a uniquely rotating alphanumeric code, a biometric, etc. in order to access the server. In other words, once the requesting user is granted access, the requesting user may still need to prove that they were the user that was granted access. In further embodiments, these authentication factors can be used to access multiple servers, as discussed in further detail below.

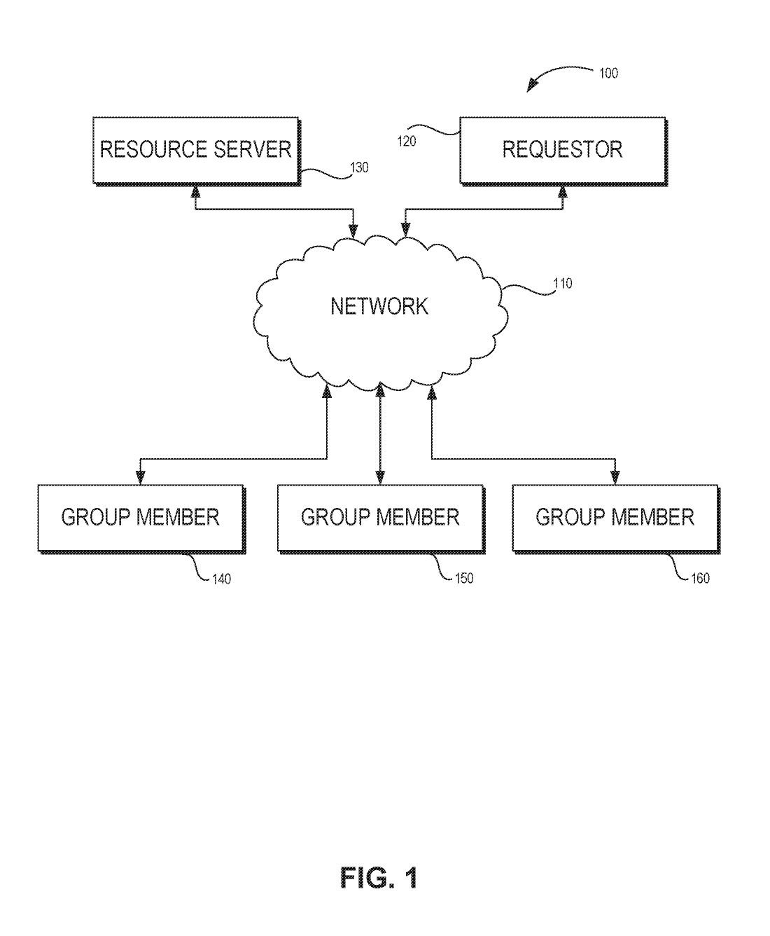

FIG. 1 illustrates an example system diagram, according to an embodiment. The system 100 can include a network 110, a requestor device 120, a resource and/or configuration server 130, a group member device 140, a group member device 150, and a group member device 160. The components of the system 100 are merely an example, and are not intended to be limiting.

The network 110 can include one or more public and/or private network, such as, for example, one or more local area networks and the internet.

The requestor device 120 can be the device of the user that is attempting to access the resource and/or configuration server 130 via the network 110. The requestor device 120 can be, for example, a personal computer, a mobile device, a server, a tablet computer, etc. The requestor device 120 can include an authorization management application that provides a UI to the requesting user. The UI can allow the user to request access to the resource and/or configuration server 130 by, for example, clicking a connect or tunnel button and specifying an amount of time for access, a time of day for access, a description of the task to be performed, and/or a reason for requesting access. In various embodiments, the UI may allow the user to input information for the request, send a communication to a separate server, and the separate server can contact group member devices and/or facilitate the connection or tunnel. In further embodiments, the requestor device 120 can communicate with the group member devices and connect or tunnel to the resource and/or configuration server 130 without the assistance of a separate server.

The resource and/or configuration server 130 can be one or more server devices that store resources (e.g., in a database) and/or provides remotely modifiable configuration settings (e.g., for another networked software system). The resource and/or configuration server 130 can include an authorization management application that can receive requests from requestor devices (e.g. the requestor device 120), determine member devices to notify (the group member devices 140-160), notify member devices, receive responses from member devices, determine whether to grant the requestor devices access to resources and/or configurations, and provide a VPN tunnel to requestor devices or use SDN to allow access.

The group member devices 140-160 can be devices of authorization group members that are predetermined to allow or deny access to the resource and/or configuration server 130 and/or to specific resources or configuration elements stored on the resource and/or configuration server 130. The group member devices 140-160 can be, for example, personal computers, mobile devices, servers, tablet computers, etc. The group member devices 140-160 can include an authorization management application that provides a UI to the authorization group user. The UI can display a notification of a request for authorization, including the amount of time and the time of day the authorization is requested for, and allow the user to allow or deny the authorization.

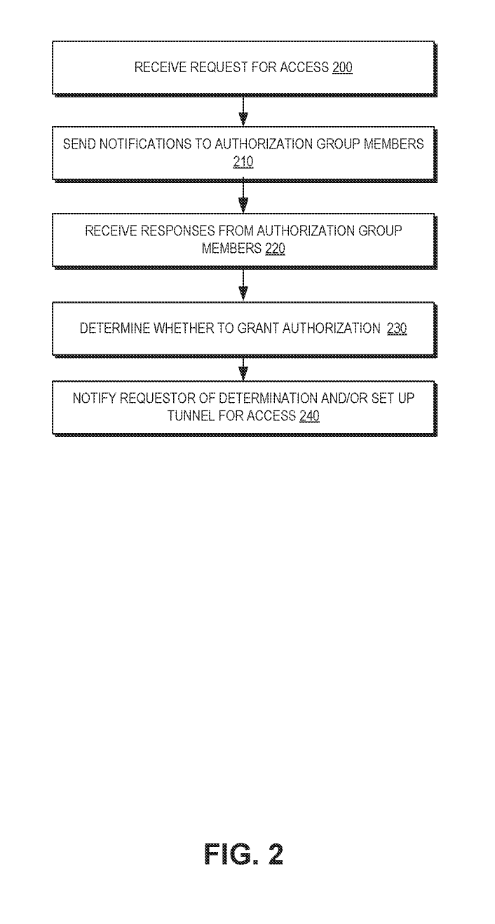

FIG. 2 illustrates an example of a method for managing authorizations, according to an embodiment. In various embodiments, the method can be performed using a computing device, such as, for example, the resource and/or configuration server 130 described above with regard to FIG. 1. The method described is merely an example, and is not intended to be limiting.

The method can begin in 200, when the computing device receives a request for access. In some embodiments, the request can be a request to access one or more resources and/or one or more configuration elements. In further embodiments, the request can be in the form of an email, a text message, etc. For example, the request can be received from the requestor device 120, as described above with regard to FIG. 1. In some implementations, the request can include an amount of time for access, a time of day for access, a description of the task to be performed, and/or a reason for requesting access.

In 210, the computing device can send one or more notifications to members in an authorization group. In some embodiments, there may be only one member in the authorization group, while, in further embodiments, the authorization group can include two or more members. The computing device can send a notification to each member in the form of an email, a text message, a push notification, etc., and the notification can, in some implementations, include an indication of the amount of time for access, the time of day for access, a description of the task to be performed, and/or a reason for requesting access. In some implementations, the authorization group members can be determined based on the resources or configuration elements associated with the request for access, while, in other implementations, the authorization group members can be determined based on the resource and/or configuration server associated with the request for access.

In 220, the computing device can receive responses from one or more authorization group members. In some embodiments, the responses can be in the form of one or more emails, one or more text messages, etc., and the responses can include an indication of whether to grant or deny authorization to the requestor device.

In 230, the computing device can determine whether to grant authorization to the requestor device. In some embodiments, the computing device can determine whether to grant authorization based on predetermined authorization rules, such as, for example, all members must approve the authorization request, only one member is needed to approve the authorization request, a certain percentage of members must approve the authorization request, at least one member must approve the authorization request and no member can deny the authorization request, a super authorizer approves the authorization request (even if other members deny the authorization request), a predetermined number of members approve the authorization request (even if a super authorizer denies the authorization request), etc. In other embodiments, the authorization request can be automatically denied if, for example, the resources or configuration elements are locked out (e.g., another user currently has been granted access).

In 240, the computing device can notify the requestor of the determination made in 230. For example, if the computing device determines to deny access, the computing device can send a notification in the form of an email, text message, push notification, etc., that indicates that authorization is denied. As another example, if the computing device determines to allow access, the computing device can send a notification in the form of an email, text message, push notification, etc., which indicates that authorization is approved, and/or the computing device can set up a VPN tunnel or use SDN to allow the requestor device to access the resource(s) and/or configuration setting(s).

In some embodiments, once the requestor is granted access, additional users may be prevented from configuration and/or remote access tunneling while the requestor is accessing the server. In further embodiments, additional users may be prevented from configuration and/or remote access tunneling for the specified time period the computing device is granted access. The computing device can determine whether to prevent access based on configured policy and/or the request.

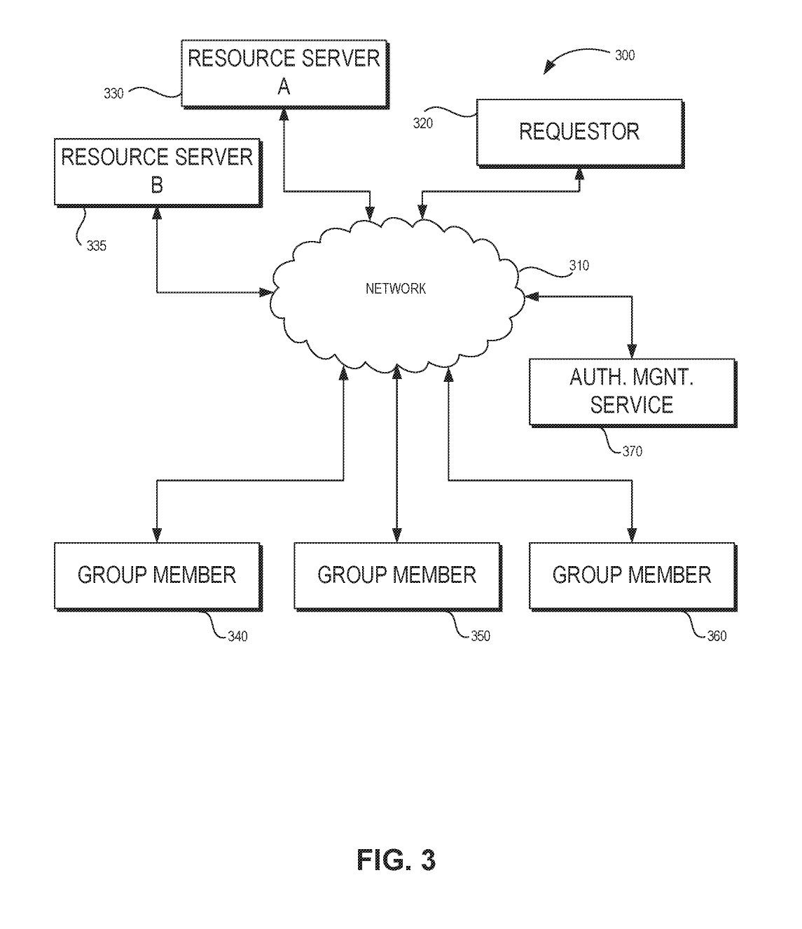

FIG. 3 illustrates an example system diagram, according to an embodiment. The system 300 can include a network 310, a requestor device 320, a resource and/or configuration server A 330, a resource and/or configuration server B 335, a group member device 340, a group member device 350, a group member device 360, and an authorization management service server 370. The components of the system 300 are merely an example, and are not intended to be limiting.

The network 310 can include one or more public and/or private network, such as, for example, one or more local area networks and the internet.

The requestor device 320 can be the device of the user that is attempting to access the resource and/or configuration server A 330 and the resource and/or configuration server B 335 via the network 310. The requestor device 320 can be, for example, a personal computer, a mobile device, a server, a tablet computer, etc. The requestor device 320 can include an authorization management application (e.g., associated with an authorization management service) that provides a UI to the requesting user. The UI can allow the user to create an account with the authorization management service and/or create or receive authentication factors. Additionally, the UI can allow the user to request access to the resource and/or configuration server A 330 and the resource and/or configuration server B 335 by, for example, clicking a connect or tunnel button and specifying an amount of time for access, a time of day for access, a description of the task to be performed, and/or a reason for requesting access. In various embodiments, if the user is granted access one or both of the resource and/or configuration servers, the user can use the authentication factors associated with their account to access both servers.

Each of the resource and/or configuration server A 330 and the resource and/or configuration server B 335 can be one or more server devices that store resources (e.g., in a database) and/or provide remotely modifiable configuration settings (e.g., for another networked software system). The resource and/or configuration servers can include an authorization management application (e.g., associated with the authorization management service) that can receive requests from requestor devices (e.g. the requestor device 320), determine member devices to notify (e.g., the group member devices 340 and 350 for the resource and/or configuration server A 330 and the group member device 360 for the resource and/or configuration server B 335), notify member devices, receive responses from member devices, determine whether to grant the requestor devices access to resources and/or configurations, and provide a VPN tunnel to requestor devices or use SDN to allow access by the requestor devices.

The group member devices 340-360 can be devices of authorization group members that are predetermined to allow or deny access to a resource and/or configuration server. For example, group member devices 340 and 350 can be predetermined to allow or deny access to the resource and/or configuration server A 330 and the group member device 360 can be predetermined to allow or deny access to the resource and/or configuration server B 335. The group member devices 340-360 can be, for example, personal computers, mobile devices, servers, tablet computers, etc. The group member devices 340-360 can include an authorization management application that provides a UI to the authorization group user. The UI can display a notification of a request for authorization, including the amount of time and the time of day the authorization is requested for, and allow the user to allow or deny the authorization.

The authorization management service server 370 can be one or more server devices that can manage and/or store information associated with user accounts for a GFA system. The authorization management service server 370 may also include and/or manage an authorization management application, and may receive requests from requestor devices (e.g. the requestor device 120) to create an account, provide and/or receive authentication factors from requestor devices, store authentication factors (e.g., in a database), and communicate with resource and/or configuration servers to verify whether a requestor device is authenticated (e.g., based on stored authentication factors).

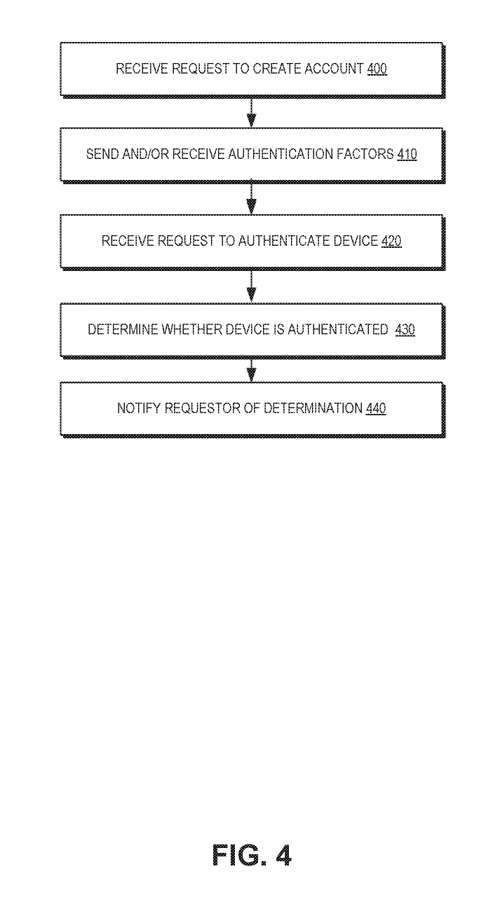

FIG. 4 illustrates an example of a method for managing authentications, according to an embodiment. In various embodiments, the method can be performed using a computing device, such as, for example, the authorization management service server 370 described above with regard to FIG. 3. The method described is merely an example, and is not intended to be limiting.

The method can begin in 400, when the computing device receives a request to create an account from a device of a user. For example, the request can be received from the requestor device 320, as described above with regard to FIG. 3. In some implementations, the request can include identification information associated with the device and/or the user (e.g., a username, an identifier of the device, a network address, etc.).

In 410, the computing device can send or receive authentication factors, such as passwords, alphanumeric codes, biometrics, etc. For example, the computing device can receive a password and/or biometrics from the device and/or provide a rotating alphanumeric code to the device (e.g., a rotating alphanumeric code that changes at regular intervals). In various embodiments, the authentication factors can be used to access one or more resource and/or configuration servers, as described above.

In 420, the computing device can receive a request to authenticate a device. For example, the request can be received from a resource and/or configuration server. In some embodiments, the request to authenticate a device can include one or more authentication factors and/or a device identifier and can be received from the device and/or from a resource and/or configuration server.

In 430, the computing device can determine whether the device is authenticated. In some embodiments, the computing device can determine whether the device is authenticated based on the authentication factors and/or the device identifier that was received. For example, the computing device can identify an account associated with the device based on the device identifier and then determine whether the authentication factors match the authentication factors associated with the account.

In 440, the computing device can notify the requestor of the determination made in 430. For example, if the computing device determines that the authentication factors do not match and/or that an account associated with the device cannot be found, then the computing device can transmit a notification that the device is not authenticated to the requestor. As another example, if the computing device determines that the authentication factors match authentication factors associated with an account of the device, the computing device can transmit a notification that the device is authenticated to the requestor (e.g., a resource and/or configuration server). In various embodiments, transmitting a notification that the device is authenticated can result in the device being granted access to a resource and/or configuration server.

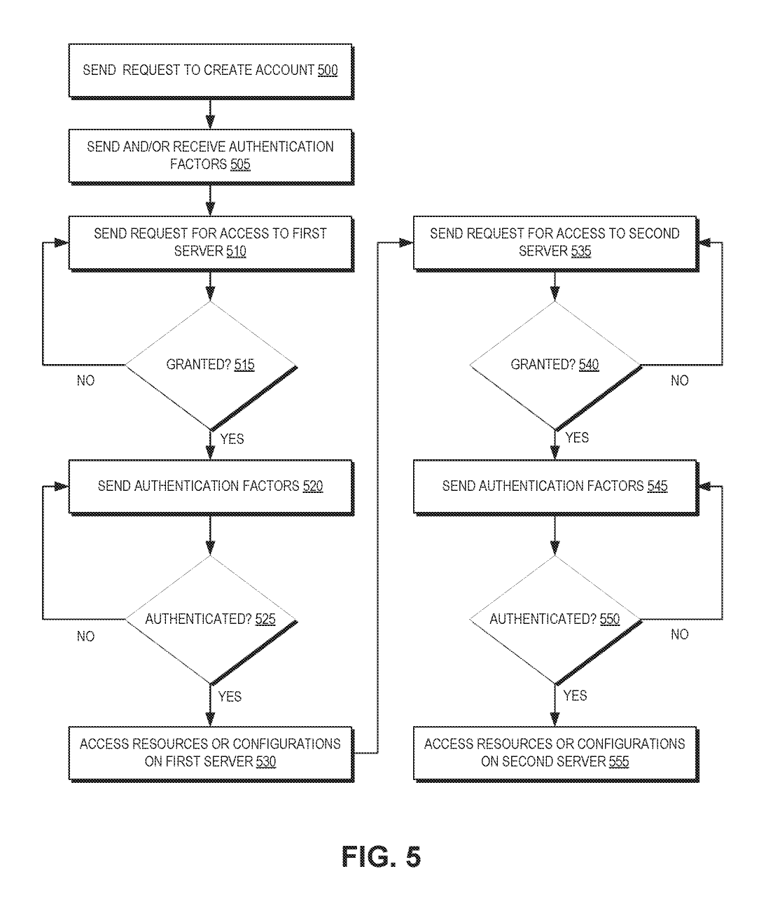

FIG. 5 illustrates an example of a method for requesting access to servers in a GFA system, according to an embodiment. In various embodiments, the method can be performed using a computing device, such as, for example, the requestor device 320 described above with regard to FIG. 3. The method described is merely an example, and is not intended to be limiting.

The method can begin in 500, when the computing device sends a request to create an account for a user of the computing device. For example, the request can be sent to the authentication management service server 370, as described above with regard to FIG. 3. In some implementations, the request can include identification information associated with the computing device and/or the user (e.g., a username, an identifier of the computing device, a network address, etc.).

In 505, the computing device can send or receive authentication factors, such as passwords, alphanumeric codes, biometrics, etc. For example, the computing device can send a password and/or biometrics and/or receive a rotating alphanumeric code (e.g., a rotating alphanumeric code that changes at regular intervals).

In 510, the computing device can send a request for access to a first resource and/or configuration server. In some embodiments, the request can be sent to one or more predetermined group member devices (e.g., the group member devices 340 and 350, as described above with regard to FIG. 3) to allow or deny access to the first resource and/or configuration server. In other embodiments, the request can be sent to an authorization management service server (e.g., the authorization management service server 370, as described above with regard to FIG. 3).

In 515, the computing device can receive an indication of whether the request for access was granted. If the request was not granted, the process can return to 510 when the computing device sends another request for access to the same or a different resource and/or configuration server. If the request was granted, the process can proceed to 520.

In 520, the computing device can send a request for authentication. In some embodiments, the request can be sent to an authorization management service server (e.g., the authorization management service server 370, as described above with regard to FIG. 3) or sent to the first resource and/or configuration server and forwarded to the authorization management service server. In some implementations, the request for authentication can include authentication factors and/or an identifier of the computing device. For example, the authentication factors can be authentication factors sent or received in 505.

In 525, the computing device can receive an indication of whether the commuting device could be authenticated. If the computing device was not authenticated, the process can return to 520 when the computing device sends another request for authentication or can return to 510 (not shown in FIG. 5) when the computing device sends another request for access to the same or a different resource and/or configuration server. If the computing device was authenticated, the process can proceed to 530.

In 530, the computing device can access the resource(s) and/or configuration setting(s) of the first server. For example, the computing device access the first server via a VPN tunnel or using SDN, as discussed above.

Subsequently, in 535, the computing device can send a request for access to a second resource and/or configuration server. In some embodiments, the request can be sent to one or more predetermined group member devices (e.g., the group member device 360, as described above with regard to FIG. 3) to allow or deny access to the second resource and/or configuration server. In other embodiments, the request can be sent to an authorization management service server (e.g., the authorization management service server 370, as described above with regard to FIG. 3).

In 540, the computing device can receive an indication of whether the request for access was granted. If the request was not granted, the process can return to 535 when the computing device sends another request for access to the same or a different resource and/or configuration server. If the request was granted, the process can proceed to 545.

In 545, the computing device can send a request for authentication. In some embodiments, the request can be sent to the authorization management service server (e.g., the authorization management service server 370, as described above with regard to FIG. 3) or sent to the second resource and/or configuration server and forwarded to the authorization management service server. In some implementations, the request for authentication can include authentication factors and/or an identifier of the computing device. For example, the authentication factors can be authentication factors sent or received in 505 and/or can be some of or all of the same authentication factors sent in 520 for access to the first server. Accordingly, some of the same authentication factors can be used to access different resource and/or configuration servers.

In 550, the computing device can receive an indication of whether the computing device could be authenticated. If the computing device was not authenticated, the process can return to 545 when the computing device sends another request for authentication or can return to 535 (not shown in FIG. 5) when the computing device sends another request for access to the same or a different resource and/or configuration server. If the computing device was authenticated, the process can proceed to 555.

In 555, the computing device can access the resource(s) and/or configuration setting(s) of the second server. For example, the computing device access the second server via a VPN tunnel or using SDN, as discussed above.

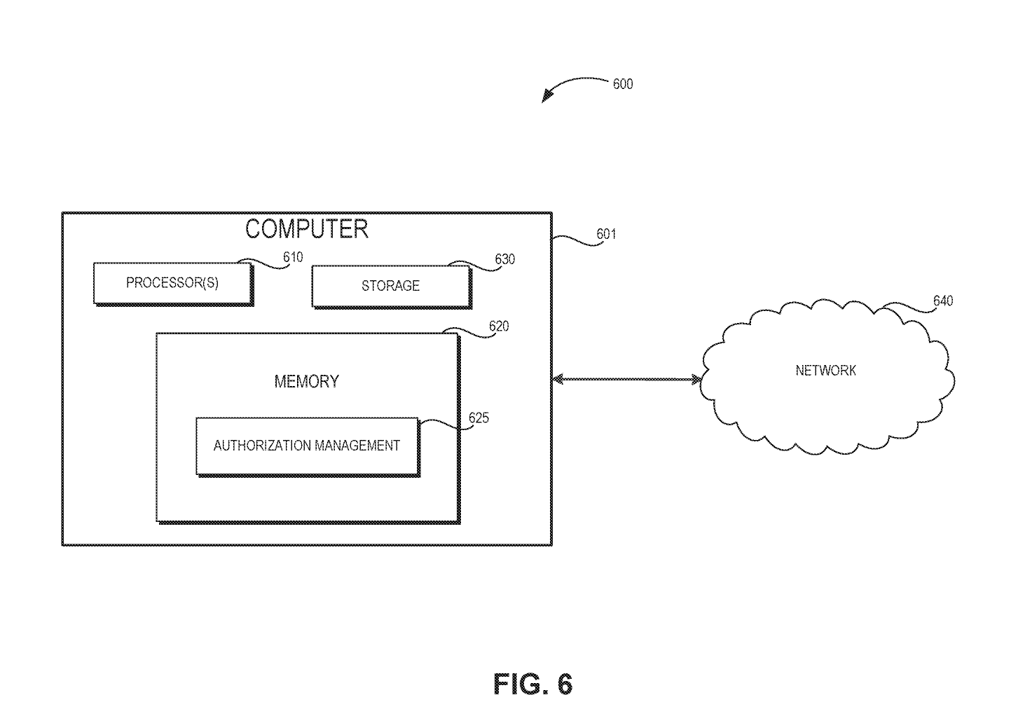

FIG. 6 illustrates an example hardware system for managing authorizations, according to an embodiment. An example hardware system 600 includes example system components that may be used. The components and arrangement, however, may be varied.

A computer 601 may include a processor 610, a memory 620, a storage 630, and input/output (I/O) devices (not pictured). The computer 601 may be implemented in various ways and can be configured to perform any of the embodiments described above. In some embodiments, the computer 601 can be, for example, a desktop computer, a laptop, a tablet device, a mobile device (e.g., a smartphone), etc. In other embodiments, the computer 601 can be a computing device such as, for example, a database server a web server, a mainframe computer, a distributed cluster of computing nodes and/or graphics processing units (GPUs), etc. The computer 601 may be standalone or may be part of a subsystem, which may, in turn, be part of a larger system.

The processor 610 may include one or more known processing devices, such as a microprocessor from the Intel Core™ family manufactured by Intel™, the Phenom™ family manufactured by AMD™, or the like. The memory 620 may include one or more storage devices configured to store information and/or instructions used by the processor 610 to perform certain functions and operations related to the disclosed embodiments. The storage 630 may include a volatile or non-volatile, magnetic, semiconductor, tape, optical, removable, non-removable, or other type of computer-readable medium used as a storage device. In some embodiments, the storage 630 can include, for example, lists of authorization groups and authorization group members, account information, authentication factors, resources, configuration settings, etc.

In an embodiment, the memory 620 may include one or more programs or subprograms including instructions that may be loaded from the storage 630 or elsewhere that, when executed by the computer 601, perform various procedures, operations, or processes consistent with disclosed embodiments. For example, the memory 620 may include authorization management program 625 for providing a UI that allows a user to request access to a server, providing a UI that displays a notification of a request for authorization and allows the user to allow or deny authorization requests, determining member devices to notify of a request, notifying member devices, receiving responses from member devices, determining whether to grant the requestor devices access to resources and/or configurations, providing a VPN tunnel to requestor devices or using SDN to allow access, creating an account with an authorization management service, managing accounts, etc., according to various disclosed embodiments. The memory 620 may also include other programs that perform other functions, operations, and processes, such as programs that provide communication support, Internet access, etc. The authorization management program 625 may be embodied as a single program, or alternatively, may include multiple sub-programs that, when executed, operate together to perform the function of the authorization management program 625 according to disclosed embodiments. In some embodiments, the authorization management program 625 can perform all or part of the process of FIGS. 2, 4, and/or 5, described above.

The computer 601 may communicate over a link with a network 640. For example, the link may be a direct communication link, a local area network (LAN), a wide area network (WAN), or other suitable connection. The network 640 may include the internet, as well as other networks, which may be connected to various systems and devices.

The computer 601 may include one or more input/output (I/O) devices (not pictured) that allow data to be received and/or transmitted by the computer 601. I/O devices may also include one or more digital and/or analog communication I/O devices that allow the computer 601 to communicate with other machines and devices. I/O devices may also include input devices such as a keyboard or a mouse, and may include output devices such as a display or a printer. The computer 601 may receive data from external machines and devices and output data to external machines and devices via I/O devices. The configuration and number of input and/or output devices incorporated in I/O devices may vary as appropriate for various embodiments.

Example uses of the system 600 can be described by way of example with reference to the embodiments described above.

While various aspects and embodiments have been disclosed herein, other aspects and embodiments will be apparent to those skilled in the art. The various aspects and embodiments disclosed herein are for purposes of illustration and are not intended to be limiting. The present disclosure is not to be limited in terms of the particular embodiments described in this application, which are intended as illustrations of various aspects. Many modifications and variations can be made without departing from its spirit and scope, as will be apparent to those skilled in the art. Functionally equivalent apparatuses within the scope of the disclosure, in addition to those enumerated herein will be apparent to those skilled in the art from the foregoing descriptions. Such modifications and variations are intended to fall within the scope of the appended claims. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of“two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” In addition, where features or aspects of the disclosure are described in terms of Markush groups, those skilled in the art will recognize that the disclosure is also thereby described in terms of any individual member or subgroup of members of the Markush group.

What is claimed is:

1. A method, comprising:
receiving a request for access to a resource or configuration element;
sending a notification to a member of an authorization group based on the request;
receiving a response to the notification;
determining whether to grant authorization to the resource or configuration element based on the response;
responding to the request for access with a notification that access is denied based on determining to deny authorization; and
establishing, via a processor, a virtual private network tunnel or using software-defined networking to allow access to the resource or configuration element based on determining to allow authorization.

2. The method of claim 1, wherein the request for access comprises at least one of an indication of an amount of time for access, a task to be performed, a time of day for access, or a reason for the request.

3. The method of claim 1, wherein the request for access is received via an email or a text message.

4. The method of claim 1, wherein the notification to the member of the authorization group comprises an email, a text message, or a push notification.

5. The method of claim 1, wherein the member of the authorization group is a plurality of members of the authorization group.

6. The method of claim 5, wherein determining whether to grant the authorization to the resource or configuration element based on the response comprises determining whether a predetermined number of members authorize the access.

7. The method of claim 1, wherein:
the resource or configuration element is stored on a first server; and
the virtual private network tunnel is established or software-defined networking is used to allow access based on authenticating a device that sent the request using an authentication factor;
the method further comprising:
receiving, from the device, a second request for access to a second resource or configuration element stored on a second server;
sending a second notification to a member of a second authorization group based on the second request;
receiving a second response to the second notification;
determining whether to grant authorization to the second resource or configuration element based on the second response;
responding to the second request for access with a notification that access is denied based on determining to deny authorization; and
establishing a virtual private network tunnel or using software-defined networking to allow access to the second resource or configuration element based on:
determining to allow authorization; and
authenticating the device using the authentication factor.

8. The method of claim 1, wherein allowing access to the resource or configuration element comprises preventing other users from accessing the resource or configuration element while the virtual private network tunnel is established or software-defined networking is used to allow access.

9. A computing system comprising:
one or more processors; and
a memory system comprising one or more non-transitory, computer-readable media storing instructions that, when executed by at least one of the one or more processors, cause the computing system to perform the method comprising:
receiving a request for access to a resource or configuration element;
sending a notification to a member of an authorization group based on the request;
receiving a response to the notification;
determining whether to grant authorization to the resource or configuration element based on the response;
responding to the request for access with a notification that access is denied based on determining to deny authorization; and
establishing a virtual private network tunnel or using software-defined networking to allow access to the resource or configuration element based on determining to allow authorization.

10. The computing system of claim 9, wherein the request for access comprises at least one of an indication of an amount of time for access, a task to be performed, a time of day for access, or a reason for the request.

11. The computing system of claim 9, wherein the request for access is received via an email or a text message.

12. The computing system of claim 9, wherein the notification to the member of the authorization group comprises an email, a text message, or a push notification.

13. The computing system of claim 9, wherein the member of the authorization group is a plurality of members of the authorization group.

14. The computing system of claim 13, wherein determining whether to grant the authorization to the resource or configuration element based on the response comprises determining whether a predetermined number of members authorize the access.

15. The computing system of claim 9, wherein:
the resource or configuration element is stored on a first server; and
the virtual private network tunnel is established or software-defined networking is used to allow access based on authenticating a device that sent the request using an authentication factor;
the method further comprising:
receiving, from the device, a second request for access to a second resource or configuration element stored on a second server;
sending a second notification to a member of a second authorization group based on the second request;
receiving a second response to the second notification;
determining whether to grant authorization to the second resource or configuration element based on the second response;
responding to the second request for access with a notification that access is denied based on determining to deny authorization; and
establishing a virtual private network tunnel or using software-defined networking to allow access to the second resource or configuration element based on:
determining to allow authorization; and
authenticating the device using the authentication factor.

16. The computing system of claim 15, wherein allowing access to the resource or configuration element comprises preventing other users from accessing the resource or configuration element while the virtual private network tunnel is established or software-defined networking is used to allow access.

17. A non-transitory, computer-readable medium storing instructions that, when executed by one or more processors of a computing system, cause the computing system to perform the method comprising:
receiving a request for access to a resource or configuration element;
sending a notification to a member of an authorization group based on the request;
receiving a response to the notification;
determining whether to grant authorization to the resource or configuration element based on the response;
responding to the request for access with a notification that access is denied based on determining to deny authorization; and
establishing a virtual private network tunnel or using software-defined networking to allow access to the resource or configuration element based on determining to allow authorization.

18. The non-transitory, computer-readable medium of claim 17, wherein the request for access comprises at least one of an indication of an amount of time for access, a task to be performed, a time of day for access, or a reason for the request.

19. The non-transitory, computer-readable medium of claim 17, wherein the notification to the member of the authorization group comprises an email, a text message, or a push notification.

20. The non-transitory, computer-readable medium of claim 17, wherein:
the resource or configuration element is stored on a first server; and
the virtual private network tunnel is established or software-defined networking is used to allow access based on authenticating a device that sent the request using an authentication factor;
the method further comprising:
receiving, from the device, a second request for access to a second resource or configuration element stored on a second server;
sending a second notification to a member of a second authorization group based on the second request;
receiving a second response to the second notification;
determining whether to grant authorization to the second resource or configuration element based on the second response;
responding to the second request for access with a notification that access is denied based on determining to deny authorization; and
establishing a virtual private network tunnel or using software-defined networking to allow access to the second resource or configuration element based on:
determining to allow authorization; and
authenticating the device using the authentication factor.
